(19) United States
(12) Patent Application Publication
(10) Pub. No.: US 2016/0044269 A1
(43) Pub. Date: Feb. 11, 2016

(54) ELECTRONIC DEVICE AND METHOD FOR CONTROLLING TRANSMISSION IN ELECTRONIC DEVICE

(71) Applicant: Samsung Electronics Co., Ltd., Gyeonggi-do (KR)

(72) Inventor: Min-Gu KANG, Daegu (KR)

(21) Appl. No.: 14/821,360

(22) Filed: Aug. 7, 2015

(30) Foreign Application Priority Data
Aug. 7, 2014 (KR) 10-2014-0101690

(51) Int. Cl. H04N 5/38; G06F 17/30; H04W 4/00

(52) U.S. Cl. CPC H04N 5/38; H04W 4/008; G06F 17/30268

(57) ABSTRACT

A method and an apparatus are provided for controlling transmission of an electronic device. One or more pieces of image data are sorted based on contact information included in tag information of each of the one or more pieces of image data. A plurality of file groups related to the contact information are created. Each of the plurality of file groups are transmitted to the related contact information.

### PRIORITY

This application claims priority under 35 U.S.C. §119(a) to Korean Patent Application Serial No. 10-2014-0101690, which was filed in the Korean Intellectual Property Office on Aug. 7, 2014, the content of which is incorporated herein by reference.

### BACKGROUND OF THE INVENTION

1. Field of the Invention

The present invention relates generally to an electronic device and a method for controlling transmission in the electronic device.

2. Description of the Related Art

Electronic devices typically include a photographing function. Photos taken by an electronic device may be shared with other people by transmitting the photos to other electronic devices. The sharing of photos requires operations of designating a receiver and selecting the photos to be transmitted. The user may then transmit the photos from his or her electronic device to another electronic device by using a selected sharing means.

In order to transmit different photos to several receivers, the operations of designating the receiver and selecting the photos to be transmitted are repeated. For example, when there are a plurality of group photos, the user sorts the photos for each individual that will receive the photos, and repeats operations of selecting the photos according to receivers, designating the receivers, and transmitting the photos, as many times as the number of the persons in the photos.

### SUMMARY OF THE INVENTION

The present invention has been made to address at least the above problems and/or disadvantages and to provide at least the advantages described below. Accordingly, an aspect of the present invention provides an electronic device, a device, and a method of controlling transmission of the electronic device by which one or more pieces of image data can be sorted according to contact information and can be conveniently transmitted.

In accordance with an aspect of the present invention, an electronic device is provided that includes a creation module configured to sort one or more pieces of image data based on contact information included in tag information of each of the one or more pieces of image data, thereby creating plurality of file groups related to the contact information. The electronic device also includes a transmission module configured to transmit each of the plurality of file groups to the related contact information.

In accordance with another aspect of the present invention, a method is provided for controlling transmission of an electronic device. One or more pieces of image data are sorted based on contact information included in tag information of each of the one or more pieces of image data. A plurality of file groups related to the contact information are created. Each of the plurality of file groups are transmitted to the related contact information. In accordance with a further aspect of the present invention, a recording medium is provided, which stores instructions that are executed by at least one processor to allow the processor to perform operations of: detecting tag information from one or more pieces of image data; sorting the one or more pieces of image data based on contact information included in the detected tag information; creating a plurality of file groups related to the contact information; and transmitting each of the plurality of file groups to the related contact information.

### BRIEF DESCRIPTION OF THE DRAWINGS

The above and other aspects, features, and advantages of the present invention will be more apparent from the following detailed description when taken in conjunction with the accompanying drawings, in which:

FIG. 1 is a block diagram illustrating an electronic device, according to an embodiment of the present invention;

FIG. 2 is a block diagram of an electronic device for controlling transmission, according to an embodiment of the present invention;

FIG. 3A is a flowchart illustrating a method for controlling transmission, according to an embodiment of the present invention;

FIG. 3B is a flowchart illustrating a method for controlling transmission, according to an embodiment of the present invention;

FIG. 4 is a flowchart illustrating a method for controlling transmission, according to an embodiment of the present invention;

FIG. 5 is a flowchart illustrating a method for controlling transmission, according to an embodiment of the present invention;

FIG. 6 is a flowchart illustrating a method for controlling transmission, according to an embodiment of the present invention;

FIG. 7 is a flowchart illustrating a method for controlling transmission, according to an embodiment of the present invention;

FIG. 8 is a flowchart illustrating a method for controlling transmission, according to an embodiment of the present invention;

FIGS. 9A to 9E are diagrams illustrating creation of file groups, according to an embodiment of the present invention; and

FIG. 10 is a block diagram illustrating an electronic device, according to an embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

The expressions “include” and “may include”, which may be used herein, denote the presence of the disclosed functions, operations, and constituent elements and do not limit one or more additional functions, operations, and constituent elements. The terms “include” and/or “have” may be construed to denote a certain characteristic, number, step, operation, constituent element, component, or a combination thereof, but may not be construed to exclude the existence or a possibility of one or more other characteristics, numbers, steps, operations, constituent elements, components, or combinations thereof.

The expression “or” includes any or all combinations of words enumerated together. For example, the expression “A or B” may include A, B, or both A and B.

Although the expressions “first” and “second”, as used herein, can modify various constituent elements, they do not limit the constituent elements. For example, the above expressions do not limit the sequence and/or importance of the corresponding elements. The above expressions may be used merely for the purpose of distinguishing one element from the other elements. For example, a first user device and a second user device indicate different user devices, although both are user devices. Without departing from the scope of the present invention, a first structural element may be referred to as a second structural element. Similarly, the second structural element may be referred to as the first structural element.

When an element is referred to as being “coupled” or “connected” to any other element, it should be understood that the element may be directly coupled or connected to the other element, or that a third element may be interposed therebetween. Contrarily, when an element is referred to as being “directly coupled” or “directly connected” to any other element, it should be understood that no element is interposed therebetween.

The terms used herein describe pecific embodiments of the present invention, and are not intended to limit the present invention. As used herein, singular forms are intended to include plural forms as well, unless the context clearly indicates otherwise.

Unless defined differently, all terms used herein, which include technical or scientific terminologies, have the same meanings as those understood by a person skilled in the art to which the present invention belongs. Such terms as those defined in a generally used dictionary are to be interpreted to have meanings equal to the contextual meanings in the relevant field of art, and are not to be interpreted to have ideal or excessively formal meanings, unless clearly defined herein.

An electronic device, according to embodiments of the present invention, may be a device including a communication function. For example, the electronic device may be embodied as at least one of a smart phone, a tablet Personal Computer (PC), a mobile phone, a video phone, an e-book reader, a desktop PC, a laptop PC, a netbook computer, a PDA, a Portable Multimedia Player (PMP), an MP3 player, a mobile medical device, a camera, and a wearable device (for example, a Head-Mounted-Device (HMD) such as electronic glasses, electronic clothes, an electronic bracelet, an electronic necklace, an electronic appcessory, an electronic tattoo, and a smart watch).

According to an embodiment of the present invention, the electronic device may be embodied as a smart home appliance with a camera function. For example, the smart home appliance may include at least one of a television, a Digital Versatile Disc (DVD) player, an audio player, a refrigerator, an air conditioner, a vacuum cleaner, an oven, a microwave oven, a washing machine, an air cleaner, a set-top box, a TV box, a game console, an electronic dictionary, an electronic key, a camcorder, and an electronic photo frame.

According to an embodiment of the present invention, the electronic device may include at least one of various types of medical devices (for example, Magnetic Resonance Angiography (MRA), Magnetic Resonance Imaging (MRI), Computed Tomography (CT), a scanning machine, an ultrasonic wave device, and the like), a navigation device, a Global Positioning System (GPS) receiver, an Event Data Recorder (EDR), a Flight Data Recorder (FDR), a car infotainment device, ship electronic equipment (for example, navigation equipment for a ship, a gyro compass, and the like), avionics, a security device, and an industrial or home robot.

According to an embodiment of the present invention, an electronic device may include at least one of a part of furniture or a building/structure having a communication function, an electronic board, an electronic signature receiving device, a projector, and various types of measuring instruments (for example, a water meter, an electric meter, a gas meter, a radio wave meter, and the like). The electronic device, according to an embodiment of the present invention, may be a combination of one or more of the aforementioned various devices. Further, it is obvious to those skilled in the art that the electronic device is not limited to the aforementioned devices.

Hereinafter, an electronic device, according to various embodiments of the present invention, will be described with reference to the accompanying drawings. The term “user”, used herein, may refer to a person who uses an electronic device or a device (for example, an artificial intelligence electronic device) that uses an electronic device.

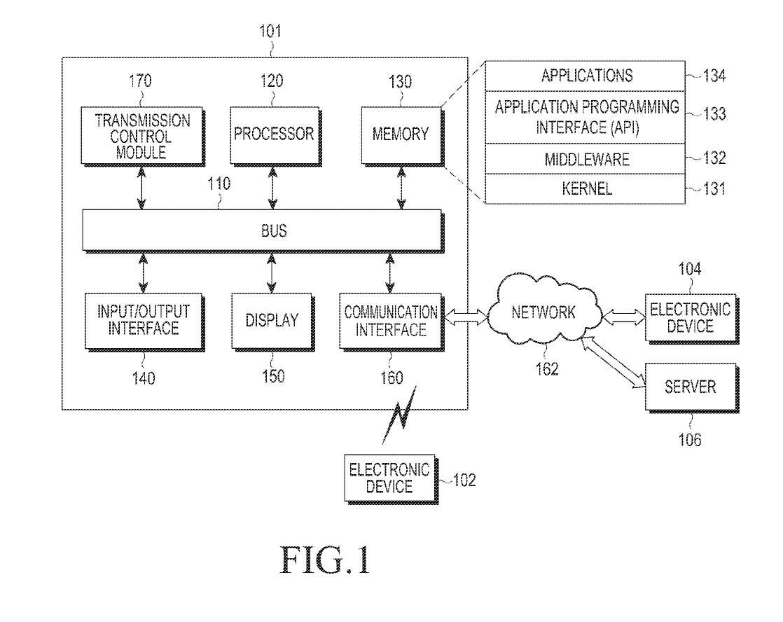

FIG. 1 is a block diagram illustrating an electronic device, according to an embodiment of the present invention. Referring to FIG. 1, an electronic device 101 includes a bus 110, a processor 120, a memory 130, an input/output interface 140, a display 150, a communication interface 160, and a transmission control module 170.

The bus 110 is a circuit for connecting the above elements with each other and transferring communication data (e.g., control messages) between the elements.

The processor 120 may receive instructions from other elements (e.g., the memory 130, the input/output interface 140, the display unit 150, the communication interface 160, or the like) through, for example, the bus 110, then may decode the received instructions and perform calculations or data processing according to the decoded instructions.

The memory 130 may store instructions or data that is received from the processor 120 or other elements (e.g., the input/output interface 140, the display unit 150, the communication interface 160, or the like), or that is created by the processor 120 or other elements. The memory 130 includes programming modules such as, for example, a kernel 131, a middleware 132, an Application Programming Interface (API) 133, or applications 134. Each of the programming modules may be configured by software, firmware, hardware, or a combination thereof.

The kernel 131 may control or manage system resources (e.g., the bus 110, the processor 120, the memory 130, or the like) that are used in performing operations or functions implemented by other programming modules, for example, the middleware 132, the API 133, or the applications 134. Furthermore, the kernel 131 may provide an interface by which the middleware 132, the API 133, or the applications 134 may access each element of the electronic device 101 for control or management.

The middleware 132 may play the intermediate role between the API 133 or the applications 134 and the kernel 131 to communicate with each other for transmission and reception of data. Furthermore, in relation to requests for operation received from the applications 134, the middleware 132 may load-balance the requests, for example, by giving priority for using system resources (e.g., the bus 110, the processor 120, the memory 130, or the like) of the electronic device 101 to at least one of the applications 134.

The API 133 is an interface by which the applications 134 control functions provided from the kernel 131 or the middleware 132, and it may include, for example, at least one interface or function for file control, window control, image processing, or text control.

The input/output interface 140 may transfer instructions or data input by the user to the processor 120 or the memory 130 through the bus 110. The display 150 may display videos, movies, or data (e.g., multimedia data or text data) to the user.

The communication interface 160 may perform communication between the electronic device 101 and external electronic devices 102 and 104 or a server 106. The communication interface 160 may support wired or wireless communication such as, for example, short-range communication (e.g., Wi-Fi, Bluetooth (BT), Near Field Communication (NFC), or the like}, network communication (e.g., Internet, Local Area Network (LAN), Wide Area Network (WAN), telecommunication network, cellular network, satellite network, or the like), a Universal Serial Bus (USB), Recommended Standard 232 (RS-232), a Plain Old Telephone Service (POTS), or the like. The electronic devices 102 and 104 may be of the same type as the electronic device 101 or may be of a different type.

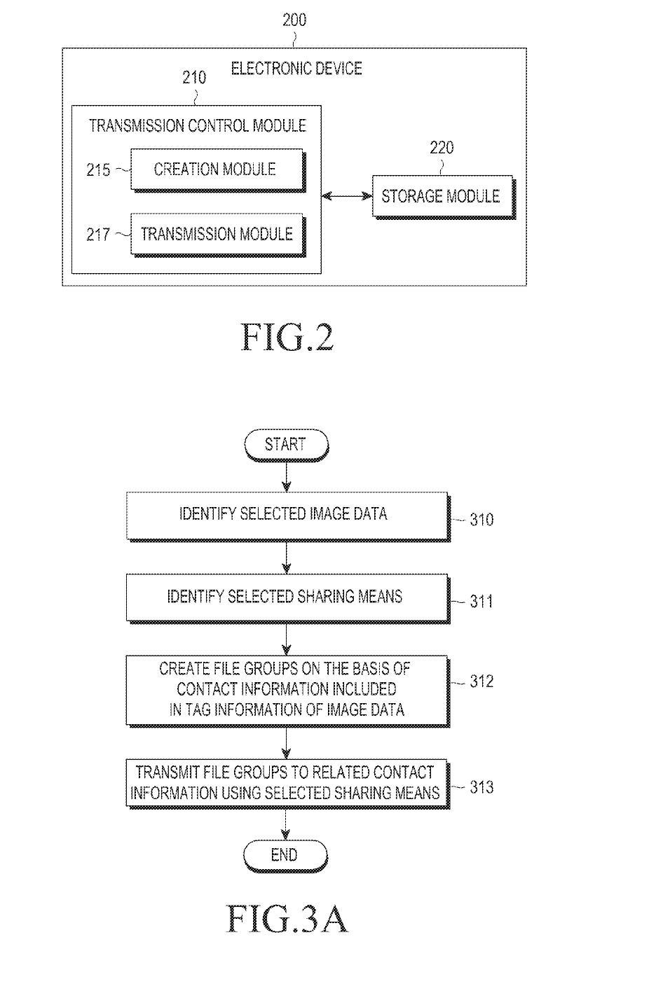

The transmission control module 170 may create file groups by assorting image data on the basis of contact information and may transmit the file groups to the corresponding receivers. The transmission control module 170 is described in greater detail below with reference to FIGS. 2 to 10.

FIG. 2 is a block diagram illustrating an electronic device for controlling transmission, according to an embodiment of the present invention. For example, an electronic device 200 may be the electronic device 101 of FIG. 1. Referring to FIG. 2, the electronic device 200 includes a transmission control module 210 and a storage module 220.

According to an embodiment of the present invention, the transmission control module 210 includes a creation module 215 and a transmission module 217. According to an embodiment of the present invention, the transmission control module 210 may be the transmission control module 170 of FIG. 1. According to another embodiment of the present invention, the transmission control module 210 may be the processor 120 of FIG. 1. The transmission control module 210 may include hardware, software, firmware, or a combination thereof.

According to an embodiment of the present invention, when one or more pieces of image data are selected, and a sharing means (e.g., messages, e-mails, messengers, short-range communication, cloud, Quick-Connect, or the like) for transmitting the selected image data is selected in the electronic device 200, the creation module 215 detects tag information (e.g., face tag information) included in one or more pieces of image data. The creation module 215 detects contact information from the detected tag information, and sorts one or more pieces of image data based on the contact information, thereby creating a plurality of file groups. When the plurality of file groups are created, the creation module 215 transmits the plurality of file groups and the contact information related to each file group to the transmission module 217. The creation module 215 displays the plurality of file groups and the contact information (e.g., name or telephone number) related to the file groups. When a request for transmission is received from the user, the creation module 215 transfers the plurality of file groups and the contact information related to the file groups to the transmission module 217. After the creation module 215 displays the plurality of file groups and the contact information related to the file groups, when a request for correcting the image data (e.g., deleting or adding image data) is received from the user, the creation module 215 corrects the plurality of file groups in response to the user's request for correction, and transfers the plurality of file groups and the contact information related to the file groups to the transmission module 217.

According to an embodiment of the present invention, after sorting one or more pieces of image data based on the contact information, thereby creating the plurality of file groups, the creation module 215 determines whether or not the selected sharing means is short-range communication. If the selected sharing means is determined to be short-range communication, the creation module 215 requests the transmission module 217 to perform a scanning operation for short-range communication, and receives information on at least one of the external devices that can make short-range communication from the transmission module 217. The creation module 215 detects one or more of the first external devices that have contact information identical to the contact information related to the plurality of file groups, from among the searched external devices. The creation module 215 transfers the information on one or more of the first external devices and at least one file group to be transmitted to one or more of the first external devices, to the transmission module 217. If there is at least one file group that has not been automatically transmitted to the searched external devices among the plurality of file groups, the creation module 215 displays a list of at least one external device, and may transfer the information on the external devices that are selected by the user in the list and at least one file group that has not been automatically transmitted to the external device, to the transmission module 217.

If the information on at least one of the searched external devices is received from the transmission module 217, the creation module 215 displays the list including the information on at least one of the searched external devices. The creation module 215 transfers the information of the searched external devices selected from the list and the file group selected from the plurality of file groups to the transmission module 217.

According to an embodiment of the present invention, the creation module 215 recognizes an object area from one or more pieces of image data by using an object recognition function. If at least one piece of the first image data exists, which does not have tag information in the recognized object area, the creation module 215 determines whether or not the contact information that matches the image information of the recognized object area exists in the contact Database (DB). For example, the creation module 215 may recognize a face area from the image data by using a face recognition function, and if the tag information does not exist in the recognized face area, the creation module 215 may determine whether or not the image information recognized in the face area matches the image information (e.g., face photos) that is stored to be related to the contact information in the contact DB. If the image information of the recognized object area does not match the contact information in the contact DB, the creation module 215 creates a certain file group that includes at least one piece of the first image data. The creation module 215 may create a plurality of certain file groups based on a similarity between the image information recognized in one or more pieces of the first image data. The creation module 215 designates the contact information selected by the user as the contact information of the certain file group. The creation module 215 transfers the certain file group and the information of the external devices that are selected by the user from the list, including the information of the searched external devices for short-range communication, to the transmission module 217. If the sharing means selected by the user is based on short-range communication, the creation module 215 transfers the certain file group with the contact information not designated to the transmission module 217.

According to an embodiment of the present invention, the creation module 215 detects uncertain tag information (e.g., face tag information), including uncertain contact information, from one or more pieces of the image data. For example, if it is uncertain about whether or not the face image of the face area, which is recognized from the image data using the face recognition function, matches the face images that are stored in relation to the contact information in the contact DB, the uncertain contact information comprised of similar contact information and special characters (e.g., “Allen?”) is included in the tag information. If the tag information including the uncertain contact information is detected, the creation module 215 requests the user to identify the tag information of the image data, which includes the uncertain contact information. When the user identifies the tag information having the uncertain contact information or requests correction thereof, the creation module 215 allows the tag information to include the uncertain tag information identified by the user, or corrects the uncertain contact information to include the corrected contact information in the tag information. For example, if the user selects “Allen?,” the tag information includes the contact information of “Allen”. Alternatively, if the user selects the contact information “Michael” stored in the contact DB, the tag information changes the contact information from “Allen?” to “Michael”.

According to an embodiment of the present invention, when one or more pieces of image data are selected and transmission of the selected image data is selected in the electronic device 200, the creation module 215 detects the tag information (e.g., face tag information) included in the one or more pieces of image data. The creation module 215 detects the contact information from the detected tag information, and sorts the one or more pieces of image data based on the contact information to thereby create a plurality of file groups. The creation module 215 detects the sharing means (e.g., messages, e-mails, messengers, short-range communication, cloud, Quick-Connect, or the like) configured in the contact information related to the plurality of file groups, and links the detected sharing means with the plurality of file groups. The creation module 215 links the defaulted sharing means with the file group related to the contact information that is not predetermined with the sharing means. The creation module 215 transfers the plurality of file groups, the contact information related to the plurality of file groups, and the sharing means information to the transmission module 217.

According to an embodiment of the present invention, the creation module 215 sorts one or more pieces of image data based on the contact information to create a plurality of file groups, and determines whether at least one piece of the second image data that has transmission information, which states that the second image data has been transmitted to the related contact information, exists in the image data included in the created file groups. If at least one piece of the second image data exists, the creation module 215 informs that the second image data is the image data that has been transmitted to the related contact information. If a request for re-transmission is received from the user, the creation module 215 may not delete one or more pieces of the second image data from the corresponding fie group. If a request for deletion is received by the user, the creation module 215 deletes one or more pieces of the second image data from the corresponding file group.

According to an embodiment of the present invention, the creation module 215 links the transmission information (e.g., transmission date or contact information) of the image data that has been transmitted to the contact information, and stores the same. If the image data selected from the image data stored in the storage module 220 has the transmission information, the creation module 215 informs the transmission information of the image data automatically or manually.

According to an embodiment of the present invention, when the plurality of file groups, the contact information related to the plurality of file groups, and the information of the sharing means selected by the user are received from the creation module, the transmission module 217 transmits the plurality of file groups to the related contact information by using the sharing means selected by the user.

When the scanning operation for short-range communication is requested from the creation module 215, the transmission module 217 performs the scanning operation, and transfers the information on at least one external device that has been searched through the scanning operation to the creation module 215. When the information on at least one external device and at least one file group to be transmitted to at least one external device are received from the creation module 215, the transmission module 217 transmits at least one file group to at least one external device by using short-range communication. When the certain file group and the information on at least one external device are received from the creation module 215 after the scanning operation for short-range communication, the transmission module 217 transmits the certain file group to at least one external device using short-range communication. When only the certain files are received from the creation module 215 after the scanning operation for short-range communication, the transmission module 217 transmits the certain files to at least one external device using short-range communication. When the plurality of file groups, the contact information related to the plurality of file groups, and the sharing means information related to the plurality of file groups are received from the creation module 215, the transmission module 217 transmits each of the file groups to the related contact information by using related sharing means.

The storage module 220 may be, for example, the memory 130 of FIG. 1. According to an embodiment of the present invention, the storage module 220 stores one or more pieces of image data, and the tag information of at least one piece of the image data includes the contact information. The storage module 220 stores the contact DB, and at least one piece of the contact information included in the contact DB includes at least one piece of the related image information (e.g., face information).

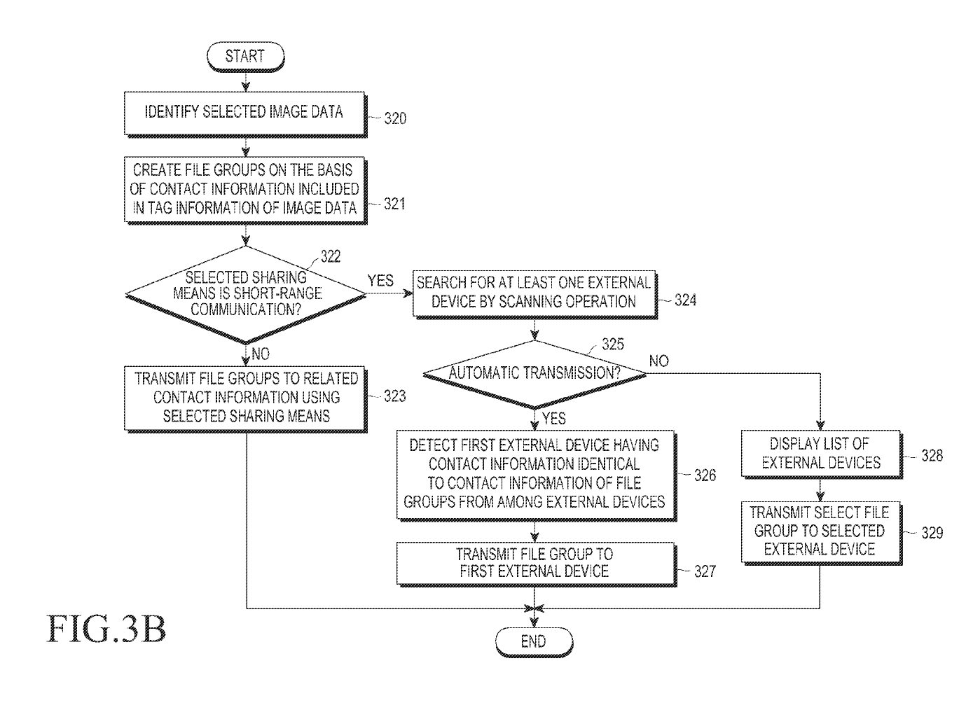

FIG. 3A is a flowchart illustrating a method for controlling transmission, according to an embodiment of the present invention. The creation module 215 identifies one or more pieces of the image data selected by the user, in step 310, and identifies the sharing means selected by the user, in step 311. In step 312, the creation module 215 detects the tag information of one or more pieces of the selected image data, and detects the contact information included in the detected tag information. The creation module 215 sorts one or more pieces of the image data based on at least one piece of the detected contact information, thereby creating a plurality of file groups, and links each file group with the detected contact information. The creation module 215 transfers the plurality of file groups, the contact information related to the plurality of file groups, and the information on the sharing means selected by the user, to the transmission module 217. In step 313, the transmission module 217 transmits at least one piece of the image data included in the plurality of file groups to the related contact information by using the sharing means selected by the user. The creation module 215 displays the plurality of file groups and the contact information related to the plurality of file groups before transmitting the plurality of file groups to thereby allow the user to identify the plurality of file groups.

FIG. 3B is a flowchart illustrating a method for controlling transmission, according to an embodiment of the present invention. The creation module 215 identifies one or more pieces of image data selected by the user, in step 320. In addition, the creation module 215 detects the tag information of the selected image data, and detects the contact information included in the detected tag information, in step 321. The creation module 215 sorts one or more pieces of the image data based on the detected contact information, thereby creating a plurality of file groups, and links each of the plurality of file groups with the detected contact information. In step 322, the creation module 215 determines whether the sharing means selected by the user is based on short-range communication.

If the sharing means selected by the user is not based on short-range communication, the creation module 215 transfers the plurality of file groups, the contact information related to the plurality of file groups, and the sharing means information, to the transmission module 217. In step 323, the transmission module 217 transmits at least one piece of the image data included in the plurality of file groups to the related contact information using the sharing means selected by the user.

If the sharing means selected by the user is based on short-range communication in step 322, the creation module 215 requests the transmission module 217 to perform a scanning operation for short-range communication. Specifically, in step 324, the transmission module 217 performs the scanning operation for short-range communication, thereby searching for at least one external device that can make short-range communication. The transmission module 217 transmits the information of at least one external device discovered through the scanning operation to the creation module 215.

In step 325, it is determined whether the creation module 215 is configured with an automatic transmission mode. If the creation module 215 is configured with an automatic transmission mode, the creation module 215 detects at least one of the first external devices that have the contact information identical to the contact information related to each of the plurality of file groups, from among the external devices, in step 326. The creation module 215 designates at least one of the first external devices as the electronic device to which at least one file group related to the contact information of at least one of the first external devices can be transmitted. The creation module 215 transfers the information of at least one of the first external devices and at least one file group that is sorted based on the contact information of at least one of the first external devices, to the transmission module 217. In step 327, the transmission module 217 transmits at least one file group that matches the contact information to at least one of the first external devices by using short-range communication.

If it is determined that the creation module 215 is not configured with an automatic transmission mode in step 325, the creation module 215 displays the list of at least one external device that has been discovered through the scanning operation for short-range communication, in step 328. The creation module 215 designates the external device selected from the list as the electronic device to which the file group selected from the plurality of file groups can be transmitted. The creation module 215 transfers the information of the external device selected from the list by the user, and the file group selected from among the plurality of file groups by the user, to the transmission module 217. In step 329, the transmission module 217 transmits the file group selected from among the plurality of file groups to the external device selected by the user by using short-range communication. Alternatively, when the information on at least one external device that is discovered through the scanning operation is received from the transmission module 217, the creation module 215 may perform steps 328 and 329, without determining whether the creation module 215 is configured with an automatic transmission mode in step 325.

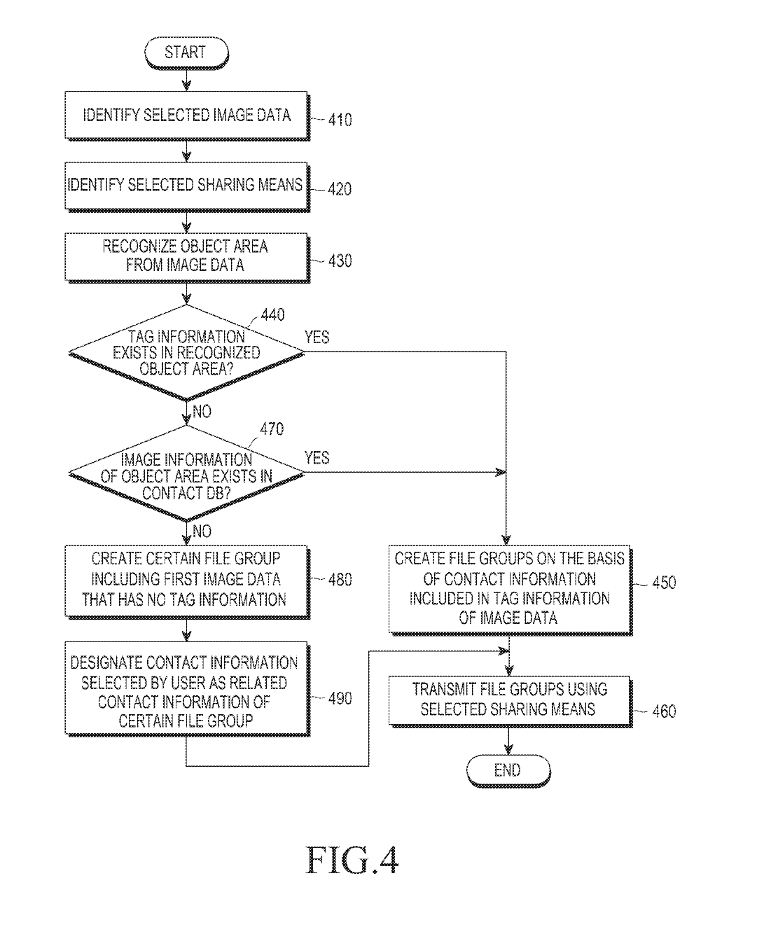

FIG. 4 is a flowchart illustrating a method for controlling transmission, according to an embodiment of the present invention. The creation module 215 identifies one or more pieces of the image data selected by the user, in step 410, and identifies the sharing means selected by the user, in step 420. The creation module 215 recognizes an object area in each of one or more pieces of the image data by using an object recognition function, in step 430. The creation module 215 determines whether or not tag information exists in the recognized object area, in step 440. If the tag information exists, the creation module 215 detects the tag information from one or more pieces of the selected image data, and detects contact information that is included in the detected tag information, in step 450. The creation module 215 sorts one or more pieces of the image data based on at least one piece of the detected contact information, thereby creating a plurality of file groups, and links each of the plurality of file groups with the detected contact information. The creation module 215 transfers the plurality of file groups, the contact information related to each of the plurality of file groups, and the information on the sharing means selected by the user, to the transmission module 217. The transmission module 217 transmits at least one piece of the image data included in the plurality of file groups to the related contact information using the sharing means selected by the user, in step 460.

If it is determined, in step 440, that at least one piece of the first image data that does not have the tag information in the recognized object area exists in one or more pieces of the image data, the creation module 215 determines whether or not the image information that is recognized in the object area matches the image information (e.g., face photos) stored to be related to the contact information in the contact DB, in step 470. If the image information recognized in the object area exists in the contact DB, the creation module 215 performs steps 450 and 460. If the image information recognized in the object area does not exist in the contact DB, the creation module 215 creates a certain file group including at least one piece of the first image data in step 480, and informs the user of the creation of the certain file group that does not have the related contact information. In step 490, if the contact information with respect to the certain file group is selected by the user, the creation module 215 designates the contact information selected by the user as the contact information related to the certain file group. The creation module 215 transfers the certain file groups, the contact information related to the certain file groups, and the information of the sharing means selected by the user, to the transmission module 217, and the transmission module 217 performs step 460.

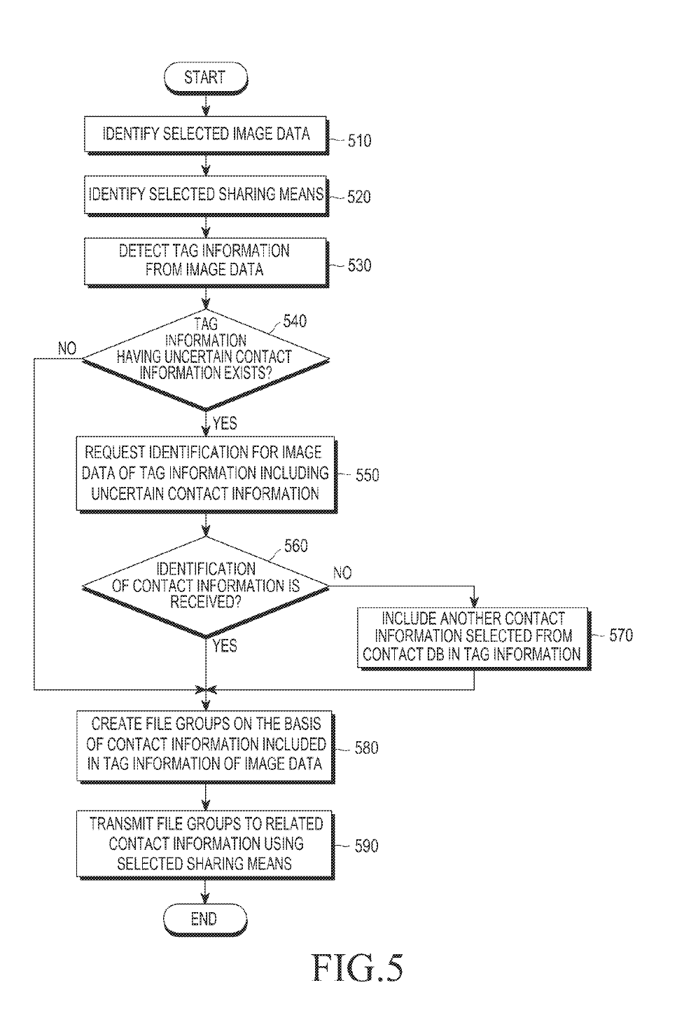

FIG. 5 is a flowchart illustrating a method for controlling transmission, according to an embodiment of the present invention. The creation module 215 identifies one or more pieces of the image data selected by the user in step 510, and identifies the sharing means selected by the user in step 520. In step 530, the creation module 215 detects the tag information of the selected image data, and detects the existence of the tag information including uncertain contact information from among the detected tag information. In step 540, the creation module 215 determines whether tag information including uncertain contact information exists in the detected tag information. If the tag information including the uncertain contact information exists, the creation module 215 requests the user to identify the tag information of the image data, which has uncertain contact information, in step 550.

In step 560, it is determined whether identification of the tag information having the uncertain contact information is received from the user. If the identification of the tag information having the uncertain contact information is received from the user, the creation module 215 corrects the uncertain contact information of the tag information into the correct contact information. If the identification of the tag information is not received from the user, another piece of the contact information is selected by the user from among the contact information in the contact DB, in step 570, and the creation module 215 corrects the uncertain contact information of the tag information into the selected contact information. In step 580, the creation module 215 sorts one or more pieces of the image data based on at least one piece of the contact information detected from the tag information to thereby create a plurality of file groups, and links the plurality of file groups with the detected contact information. The creation module 215 transfers the plurality of file groups, the contact information related to each of the plurality of file groups, and the information on the sharing means selected by the user, to the transmission module 217. The transmission module 217 transmits at least one piece of the image data included in the plurality of file groups to the related contact information using the sharing means selected by the user, in step 590.

If it is determined that the tag information including uncertain contact information does not exists in the detected tag information in step 540, the creation module 215 performs steps 580 and 590.

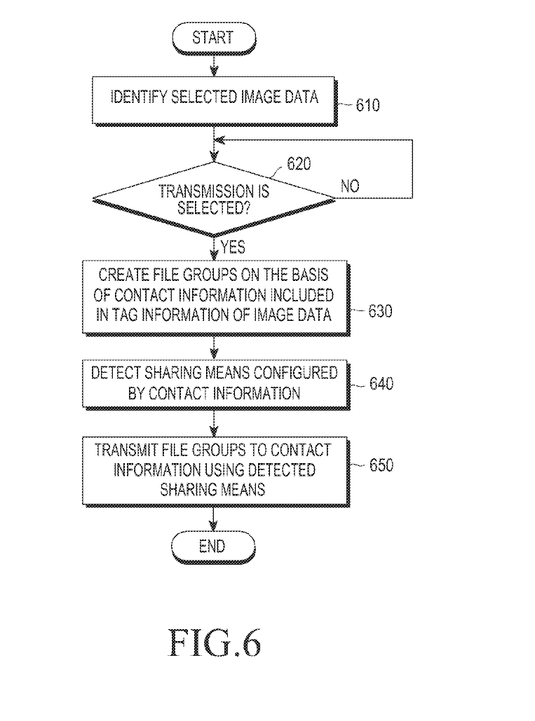

FIG. 6 is a flowchart illustrating a method for controlling transmission, according to an embodiment of the present invention The creation module 215 identifies one or more pieces of the image data that are selected for transmission by the user, in step 610. In step 620, it is determined whether transmission is selected for the one or more pieces of the image data. If the transmission of one or more pieces of the image data is selected, the creation module 215 detects the tag information of the selected image data, and detects the contact information included in the detected tag information. In step 630, the creation module 215 sorts one or more pieces of the image data based on at least one piece of the detected contact information, thereby creating a plurality of file groups, and links each of the plurality of file groups with the detected contact information. In step 640, the creation module 215 detects the sharing means configured in the contact information related to the plurality of file groups, and links each of the plurality of file groups with the detected sharing means. Additionally, in step 640, the creation module 215 links the file group related to the contact information in which the sharing means is not predetermined with the defaulted sharing means. The creation module 215 transfers the plurality of file groups, the contact information related to each of the plurality of file groups, and the information on the sharing means related to each of the plurality of file groups to the transmission module 217. In step 650, the transmission module 217 transmits each of the plurality of file groups to the related contact information by using the related sharing means.

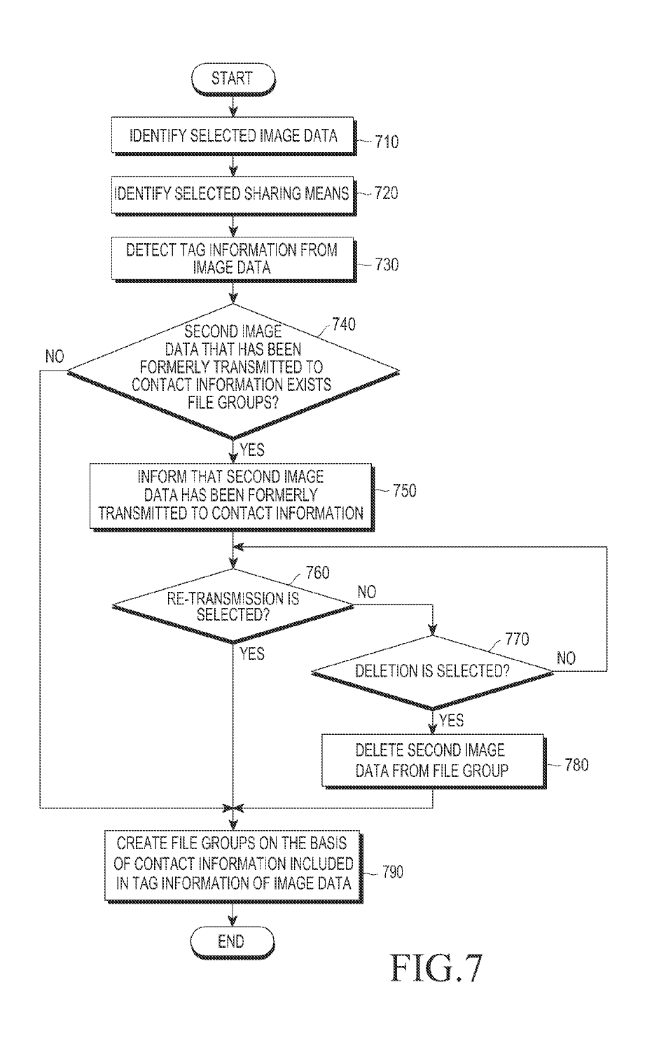

FIG. 7 is a flowchart illustrating a method for controlling transmission, according to an embodiment of the present invention. The creation module 215 identifies one or more pieces of the image data selected by the user, in step 710, and identifies the sharing means selected by the user, in step 720. In step 730, the creation module 215 detects the tag information of the selected image data, and detects the contact information included in the detected tag information. In step 730, the creation module 215 sorts one or more pieces of the image data based on at least one piece of the detected contact information, thereby creating a plurality of file groups, and links each of the plurality of file groups with the detected contact information.

In step 740, the creation module 215 determines whether at least one piece of second image data, which has transmission information stating that the second image data has been transmitted to the related contact information, exists in the image data included in the plurality of file groups. If at least one piece of the second image data exists, the creation module 215 informs the user that the second image data has been transmitted to the related contact information, in step 750.

In step 760, the creation module 215 determines whether a request for retransmitting the second image data is received from the user. If the request for retransmitting the second image data is received, the creation module 215 may sorts one or more pieces of the image data including the second image data based on at least one piece of the detected contact information, thereby creating a plurality of file groups, and links each of the plurality of file groups with the detected contact information, in step 790. The creation module 215 transfers the plurality of file groups, the contact information related to each of the plurality of file groups, and the information on the sharing means related to each of the plurality of file groups, to the transmission module 217. The transmission module 217 transmits each of the plurality of file groups to the related contact information by using the related sharing means.

If the request for retransmitting the second image data is not received from the user in step 760, the creation module 215 determines whether a request for deleting the second image data is received from the user, in step 770. If the request for deleting the second image data is received, the second image data is deleted from the corresponding file group. The creation module 215 then performs step 790, as described above. If the request for deleting the second image data is not received, the creation module returns to step 760.

Returning to step 740, if the creation module 215 determines that at least one piece of second image data, which has transmission information stating that the second image data has been transmitted to the related contact information, does not exists in the image data included in the plurality of file groups, the creation module 215 performs step 790, as described above.

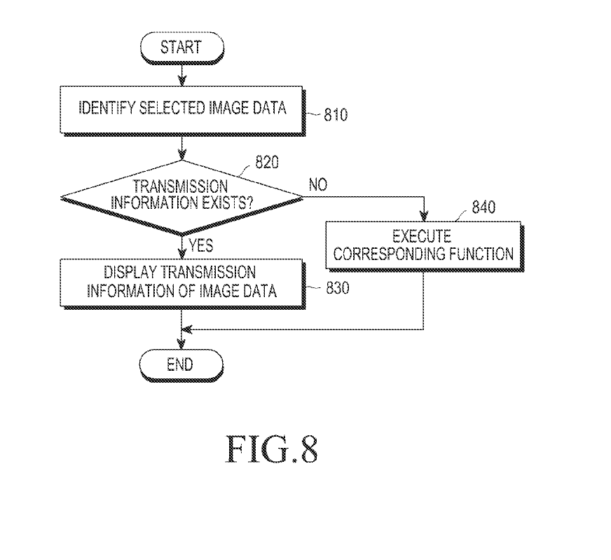

FIG. 8 is a flowchart illustrating a method for controlling transmission, according to an embodiment of the present invention. In step 810, the creation module 215 identifies the image data selected by the user among one or more pieces of the image data stored in the storage module 220. In step 820, the creation module 215 determines whether or not the image data selected by the user includes the transmission information. If the image data selected by the user has the transmission information, the creation module 215 displays the transmission information (e.g., transmission date, transmission time, contact information, or the like) of the image data while displaying the image data in step 830. If the image data does not have the transmission information, a corresponding function is executed in step 840.

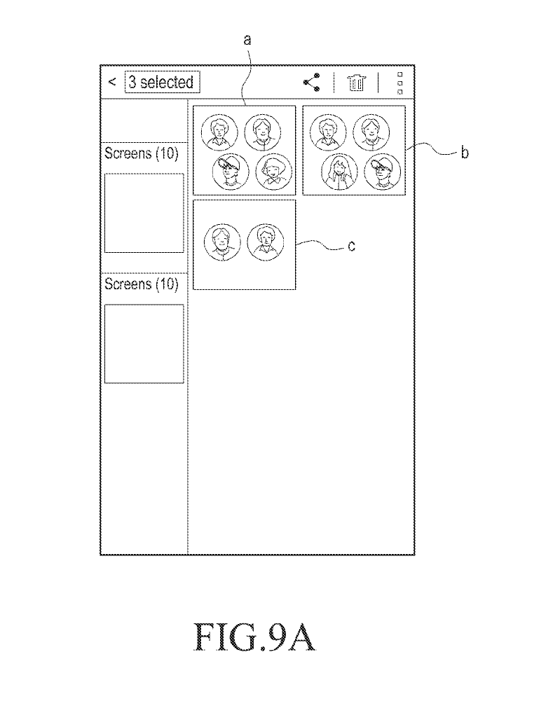

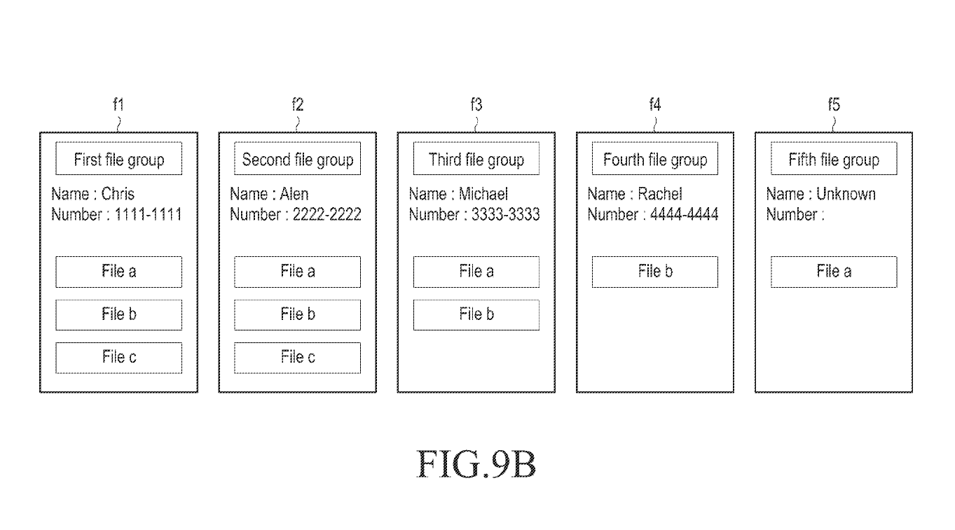

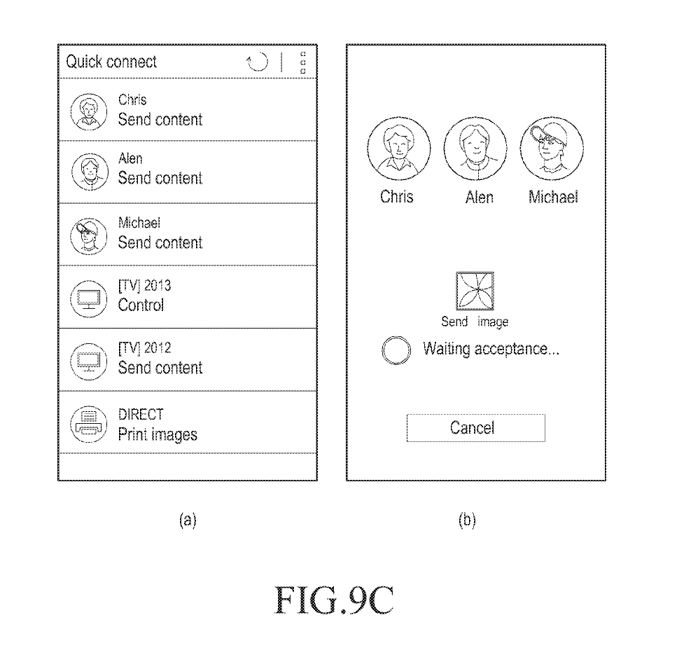

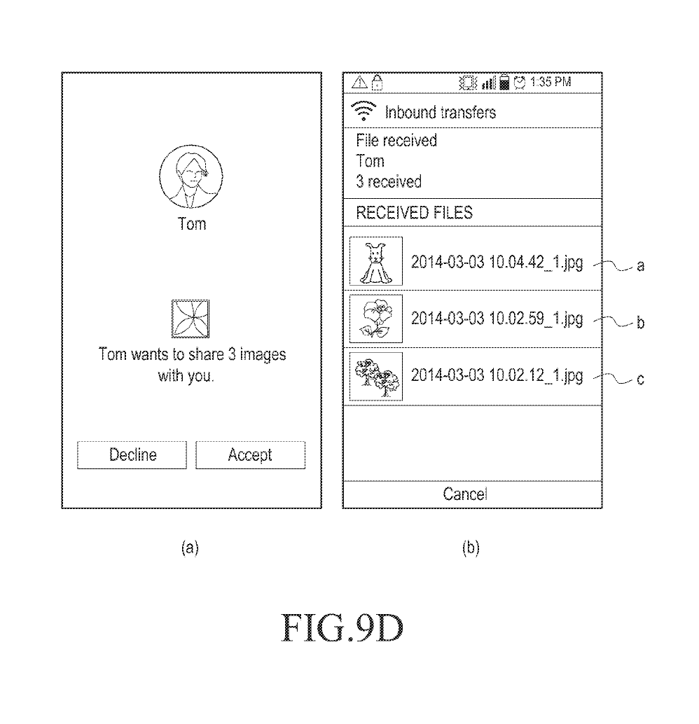

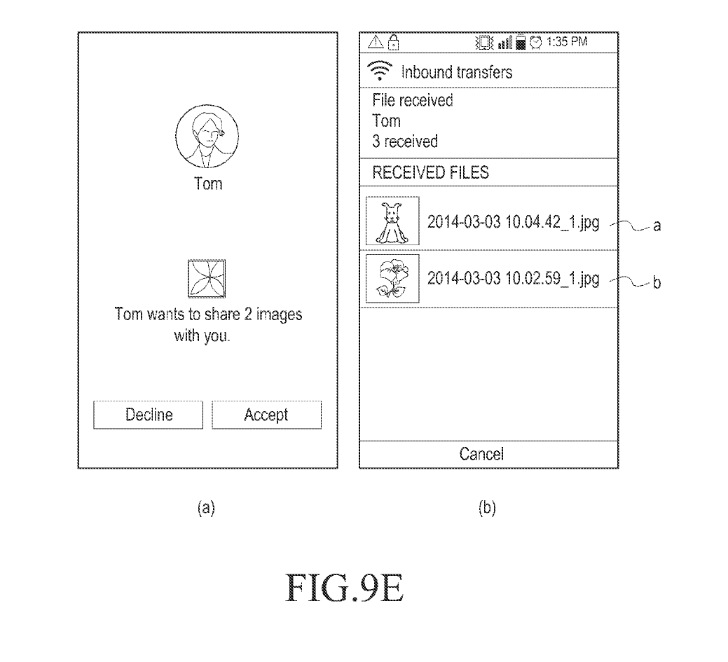

FIGS. 9A to 9E are diagrams illustrating creation of creating file groups, according to an embodiment of the present invention. FIGS. 9A to 9E illustrate that one or more pieces of the image data selected for transmission are sorted based on the contact information into a plurality of file groups.

As shown in FIG. 9A, when the first image data “a” and the second image data “b”, which include four known persons, i.e., “Chris,” “Allen,” “Michael,” and “Rachel,” and an unknown person who is not stored in the contact DB, and the third image data “c,” which includes two persons, i.e., “Chris” and “Allen,” are selected from among one or more pieces of the image data stored in the storage module 220, the creation module 215 detects the tag information from the three pieces of image data “a,” “b,” and “c,” and detects the contact information, i.e., “Chris,” “Allen,” “Michael,” and “Rachel” included in the detected tag information.

As shown in FIG. 9B, the creation module 215 creates five file groups based on the detected contact information. The first file group f1 includes the first image data “a,” the second image data “b,” and the third image data “c,” which have the tag information with the contact information of “Chris” and “111-1111.” The second file group f2 includes the first image data “a,” the second image data “b” and the third image data “c,” which have the tag information with the contact information of “Allen” and “222-2222.” The third file group f3 includes the first image data “a” and the second image data “b,” which have the tag information with the contact information of “Michael” and “333-3333.” The fourth file group f4 includes the second image data “b” that has the tag information with the contact information of “Rachel” and “444-4444.” The fifth file group f5 includes the first image data “a” that includes the unknown person who is not stored in the contact DB.

After three pieces of data are sorted into five file groups, the creation module 215 receives the contact information from external devices through the sharing means, for example, Quick Connect, selected by the user, and displays the external devices to which the contact information has been transmitted. If the contact information received from the external devices matches the contact information stored in the contact DB, the creation module 215 displays the existence of the external devices as the contact information.

As shown in diagram (a) of FIG. 9C, when the file transmission to “Chris,” “Allen,” and “Michael” is requested while “Chris,” “Allen,” and “Michael” stored in the contact DB are displayed, among the external devices that have transmitted the contact information, the electronic device 200 waits for “Chris,” “Allen,” and “Michael” to accept the file transmission as shown in diagram (b) of FIG. 9C.

Diagram (a) of FIG. 9D shows that each of the electronic devices of “Chris” and “Allen” informs that the file transmission is requested by the user, i.e., “Tom,” of the electronic device 200. Diagram (b) of FIG. 9D shows that the first image data “a,” the second image data “b,” and the third image data “c” received from the electronic device 200 are displayed when the request for file transmission by the user, i.e., “Tom,” of the electronic device 200 is accepted in the electronic devices of “Chris” and “Allen,” respectively.

Diagram (a) of FIG. 9E shows that the electronic device of “Michael” informs that the file transmission is requested by the user, i.e., “Tom,” of the electronic device 200. Diagram (b) of FIG. 9E shows that the first image data “a” and the second image data “b” received from the electronic device 200 are displayed when the request for file transmission by the user, i.e., “Tom,” of the electronic device 200 is accepted in the electronic device of “Michael”.

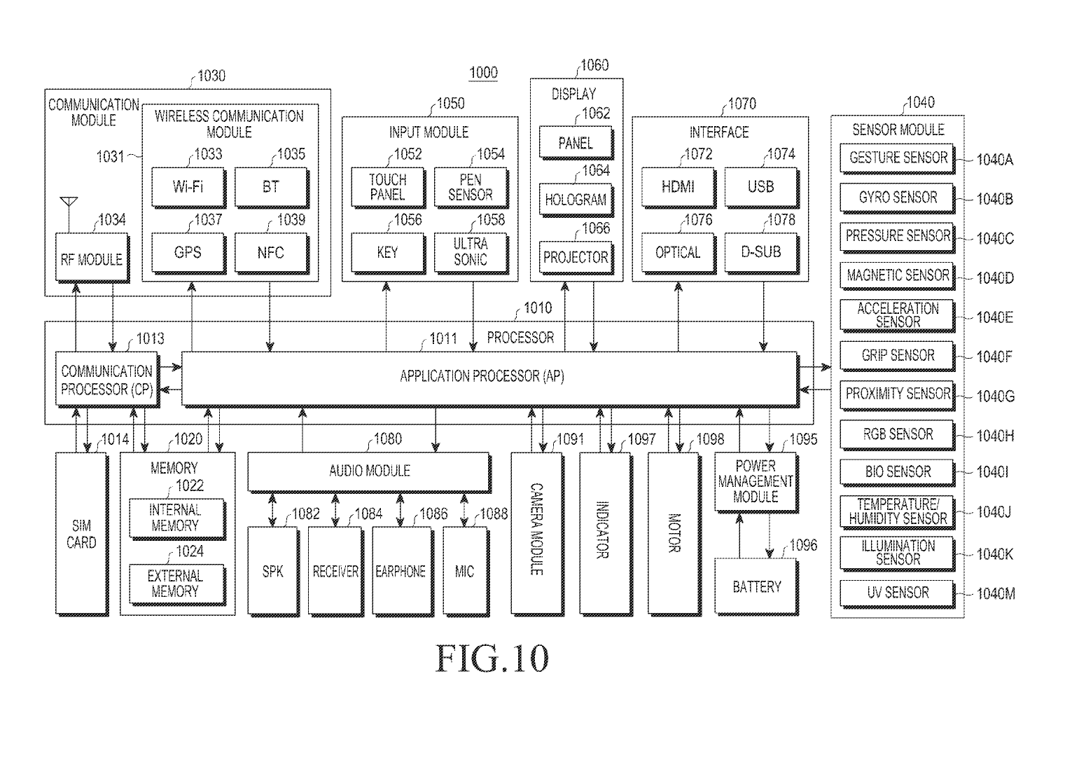

FIG. 10 is a block diagram illustrating an electronic device, according to an embodiment of the present invention. For example, an electronic device 1000 of FIG. 10 may constitute a part of or all of the electronic device 100 shown in FIG. 1. Referring to FIG. 10, the electronic device 1000 includes at least one processor 1010, a Subscriber Identification Module (SIM) card 1014, a memory 1020, a communication module 1030, a sensor module 1040, an input module 1050, a display 1060, an interface 1070, an audio module 1080, a camera module 1091, a power management module 1095, a battery 1096, an indicator 1097, and a motor 1098.

The processor 1010 includes at least one Application Processor (AP) 1011 or at least one Communication Processor (CP) 1013. The processor 1010 may be the processor 120 of FIG. 1. Although the AP 1011 and the CP 1013 are included in the processor 1010 in FIG. 10, the AP 1011 and the CP 1013 may be included in different IC packages, respectively. According to an embodiment of the present invention, the AP 1011 and the CP 1013 may be included in a single IC package.

The AP 1011 may control a multitude of hardware or software elements connected with the AP 1011 and perform processing of various pieces of data including multimedia data and calculation, by performing an operating system or application programs. The AP 1011 may be implemented by, for example, a System on Chip (SoC). According to an embodiment of the present invention, the processor 1010 may further include a Graphics Processing Unit (GPU).

The CP 1013 may manage data link in communication between the electronic device 1000 and other electronic devices connected with the electronic device 1000 through networks, and may transform communication protocols. The CP 1013 may be implemented by, for example, an SoC. According to an embodiment of the present invention, the CP 1013 may perform at least some of the multimedia control functions. For example, the CP 1013 may perform identification and authentication of the electronic device 1000 in communication networks by using the SIM (e.g., SIM card 1014). In addition, the CP 1013 may provide services such as, for example, phone calls, video calls, text messages or packet data to the user. Furthermore, the CP 1013 may control transmission and reception of data of the communication module 1030. Although the elements, such as the CP 1013, the power management module 1095 or the memory 1020, are separated from the AP 1011 in FIG. 10, according to an embodiment of the present invention, the AP 1011 may be configured to include at least some (e.g., CP 1013) of the above elements.

According to an embodiment of the present invention, the AP 1011 or the CP 1013 may load instructions or data received from at least one of the non-volatile memories or other elements, which are connected with the AP 1011 or the CP 1013, to volatile memories and may process the same. In addition, the AP 1011 or the CP 1013 may store data that is received or created from or by at least one of other elements in non-volatile memories.

The SIM card 1014 , may be inserted into a slot formed at a predetermined position of the electronic device 1000. The SIM card 1014 may include an inherent identification information (e.g., an Integrated Circuit Card Identifier (ICCID)) or subscriber information (e.g., an International Mobile Subscriber Identity (IMSI)).

The memory 1020 includes an internal memory 1022 or an external memory 1024. For example, the memory 1020 may be the memory 130 of FIG. 1. The internal memory 1022 may include at least one of volatile memories (e.g., a Dynamic RAM (DRAM), a Static RAM (SRAM), a Synchronous DRAM (SDRAM), or the like) or non-volatile memories {e.g., an One Time Programmable ROM (OTPROM), a Programmable ROM (PROM), an Erasable PROM (EPROM), an Electrically EROM (EEPROM), a mask ROM, a flash ROM, a NAND flash memory, a NOR flash memory, or the like). According to an embodiment of the present invention, the internal memory 1022 may be a Solid State Drive (SSD). The external memory 1024 may further include a flash drive, for example, a Compact Flash (CF), a Secure Digital (SD), aMicro-SD, a Mini-SD, an extreme Digital (xD), a memory stick, or the like. The external memory 1024 may be functionally connected with the electronic device 1000 through various interfaces.

The electronic device 1000 may further include a storage device (or a storage medium) such as a hard drive.

The communication module 1030 includes a wireless communication module 1031 or an RF module 1034. For example, the wireless communication module 1030 may be the communication module 160 of FIG. 1. The wireless communication module 1031 includes a Wi-Fi module 1033, a BT module 1035, a GPS module 1037, and a Near Field Communication (NFC) module 1039. For example, the wireless communication module 1031 may provide a wireless communication function by using a radio frequency. Alternatively or additionally, the wireless communication module 1031 may include network interfaces (e.g., LAN card) or modems for connecting the electronic device 1000 to networks {e.g., Internet, LAN, WAN, telecommunication network, cellular network, satellite network, POTS, or the like).

The RF module 1034 may transmit and receive voice signals or data signals. The RF module 1034 may include, for example, a transceiver, a Power Amp Module (PAM), a frequency filter, a Low Noise Amplifier (LNA), or the like. For example, the RF module 1034 may further include components such as conductors or cables for transmitting and receiving electromagnetic waves through free space in wireless communication.

The sensor module 1040 includes at least one of, for example, a gesture sensor 1040A, a gyro-sensor 1040B, an atmospheric pressure sensor 1040C, a magnetic sensor 1040D, an acceleration sensor 1040E, a grip sensor 1040F, a proximity sensor 1040G, a Red-Green-Blue (RGB) sensor 1040H, a bio sensor 10401, a temperature/humidity sensor 1040J, an illuminance sensor 1040K, an Ultra Violet (UV) sensor 1040M, or an InfraRed (IR) sensor. The sensor module 1040 may measure physical quantities and may detect an operation state of the electronic device, to thereby convert the measured or detected information to electric signals. Alternatively or additionally, the sensor module 1040 may further include an E-nose sensor, an electromyography sensor (EMG) (not shown), an electroencephalogram sensor (EEG), an electrocardiogram sensor (ECG), a fingerprint sensor, or the like. The sensor module 1040 may further include a control circuit for controlling at least one sensor included therein.

The input module 1050 includes a touch panel 1052, a (digital) pen sensor 1054, keys 1056, or an ultrasonic input device 1058. For example, the input module 1050 may be included in the input/output interface 140 of FIG. 1. The touch panel 1052 may recognize a touch input by at least one of, for example, a capacitive type, a pressure type, an infrared type, or an ultrasonic type. In addition, the touch panel 1052 may further include a controller. In the case of a capacitive type, a physical contact or access can be detected. The touch panel 1052 may further include a tactile layer. In this case, the touch panel 1052 may provide the user with a tactile reaction.

For example, the (digital) pen sensor 1054 may be implemented by using, for example, a method that is the identical or similar to the user's touch input or by using a separate recognition sheet. The keys 1056 may include, for example, physical buttons, optical keys, a keypad, or a touch key. The ultrasonic input device 1058 detects acoustic waves with a microphone (e.g., a microphone 1088) through an input means that generates ultrasonic signals to thereby identify data. The ultrasonic input device 1058 may perform wireless recognition. According to an embodiment of the present invention, the electronic device 1000 may receive a user input from external devices (e.g., networks, computers, or servers), which are connected with the electronic device by using the communication module 1030.

The display 1060 includes a panel 1062, a hologram device 1064, or a projector 1066. For example, the display 1060 may be the display 150 of FIG. 1. The panel 1062 may be, for example, a Liquid Crystal Display (LCD), an Active Matrix-Organic Light Emitting Diode (AM-OLED), or the like. The panel 1062 may be implemented to be, for example, flexible, transparent or wearable. The panel 1062 may be configured with the touch panel 1052 as a single module. The hologram device 1064 may display 3D images in the air by using interference of light. The projector 1066 may display images by projecting light onto a screen. According to an embodiment of the present invention, the display 1060 may further include a control circuit for controlling the panel 1062, the hologram device 1064, or the projector 1066.

The interface 1070 may include, for example, a High-Definition Multimedia Interface (HDMI) 1072, a Universal Serial Bus (UBS) 1074, an optical interface 1076, or a D-subminiature (D-sub) 1078. For example, the interface 1070 may be included in the communication interface 760 of FIG. 1. Additionally or alternatively, the interface 1070 may include, for example, an SD card/Multi-Media Card (MMC) or an Infrared Data Association (IrDA).

The audio module 1080 may convert a sound into an electric signal, and vice versa. The audio module 1080 may be included, for example, in the input/output interface 140 shown in FIG. 1. For example, the audio module 1080 may process voice information input or output through a speaker 1082, a receiver 1084, an earphone 1086 or the microphone 1088.

The camera module 1091 is a device for photographing still and moving images, and it may include at least one image sensor (e.g., a front sensor or a rear sensor), lenses, an Image Signal Processor (ISP), or a flash (e.g., LED or a xenon lamp), according to an embodiment of the present invention.

The power management module 1095 may manage power of the electronic device 1000. Although not shown, the power management module 1095 may include, for example, a Power Management Integrated Circuit (PMIC), a charger IC, or a battery gauge.

The PMIC may be mounted, for example, in integrated circuits or SoC semiconductors. The charging may be conducted by a wired type and a wireless type. The charger IC may charge a battery and may prevent inflow of an excessive voltage or current from the charger. According to an embodiment of the present invention, the charger IC may include a charger IC for at least one of the wired charging type or the wireless charging type. The wireless charging type may encompass, for example, a magnetic resonance type, a magnetic induction type or an electromagnetic wave type, and additional circuits for wireless charging, for example, coil loops, resonance circuits, rectifiers, or the like, may be provided.

The battery gauge may measure, for example, the remaining power of the battery 1096, a charging voltage and current, or temperature. The battery 1096 may store and supply power to the electronic device. The battery 1096 may include, for example, a rechargeable battery or a solar battery.

The indicator 1097 may display a specific state, for example, a booting state, a message state, or a charging state of the whole or a part (e.g., the AP 1011) of the electronic device 1000. The motor 1098 may convert electric signals to a mechanical vibration.

The electronic device 1000 may include a processing device (e.g., the GPU) for supporting a mobile TV. The processing device for supporting a mobile TV may process media data according to the standard such as, for example, digital multimedia broadcasting (DMB), digital video broadcasting (DVB) or media flow.

Each of the components of the electronic device, according to embodiments of the present invention, may be implemented by one or more components, and the name of the corresponding component may vary depending on a type of the electronic device. The electronic device, according to embodiments of the present invention, may include one or more of the aforementioned components or may further include other additional components, or some of the aforementioned components may be omitted. Further, some of the components of the electronic device, according to the embodiments of the present invention, may be combined to be one entity, which can perform the same functions as those of the components before the combination.

The term “module”, as used herein, may refer to, for example, a unit including one or more combinations of hardware, software, and firmware. The “module” may be interchangeable with a term such as unit, logic, logical block, component, or circuit. The module may be a minimum unit of an integrated component element or a part thereof. The module may be a minimum unit for performing one or more functions or a part thereof. The module may be mechanically or electronically implemented. For example, the module, according embodiments of the present invention, may include at least one of an Application-Specific Integrated Circuit (ASIC) chip, a Field-Programmable Gate Arrays (FPGA), and a programmable-logic device for performing operations, which have been known or are to be developed hereinafter.

According to various embodiments of the present invention, a recording medium stores instructions that are executed by at least one processor to allow the processor to perform operations of: detecting tag information from one or more pieces of image data; sorting one or more pieces of image data based on contact information included in the detected tag information; creating a plurality of file groups related to the contact information; and transmitting each of the plurality of file groups to the related contact information. The electronic device, according to various embodiments of the present invention, may receive and store a program including commands which cause the electronic device to perform a certain method. The electronic device or the server illustrated in FIG. 1 may be the program providing apparatus. The program providing device may include a memory for storing the program, a communication module to execute wired or wireless communication with an electronic device, and a processor that transmits a corresponding program to the electronic device automatically or in response to the electronic device.

While the invention has been shown and described with reference to certain embodiments thereof, it will be understood by those skilled in the art that various changes in form and detail may be made therein without departing from the spirit and scope of the invention as defined by the appended claims.

What is claimed is:

1. An electronic device comprising:
a creation module configured to sort one or more pieces of image data based on contact information included in tag information of each of the one or more pieces of image data, thereby creating plurality of file groups related to the contact information; and
a transmission module configured to transmit each of the plurality of file groups to the related contact information.

2. The electronic device of claim 1, wherein the creation module is further configured to display the plurality of file groups and the contact information related to the plurality of file groups.

3. The electronic device of claim 1, wherein the creation module is further configured to, when short-range communication is selected as a sharing means, for each of the plurality of file groups, detect at least one external device that has contact information identical to the related contact information, from among one or more external devices discovered through a scanning operation, and designate the at least one external device as an electronic device to which a respective file group can be transmitted.

4. The electronic device of claim 1, wherein the creation module is further configured to, when short-range communication is selected as a sharing means, to display a list of at least one external device discovered through a scanning operation, and designate the external device selected from the list as the electronic device to which a file group selected from the plurality of file groups can be transmitted.

5. The electronic device of claim 1, wherein the creation module is further configured to determine whether a contact database includes contact information for at least one piece of the image data when the at least one piece of the image data does not have tag information, create a certain file group including the at least one piece of the image data when the contact database does not have the contact information for the at least one piece of the image data, and designate contact information selected by a user as the contact information of the certain file group.

6. The electronic device of claim 1, wherein the creation module is further configured to, when the tag information includes uncertain contact information, request a user to identify the tag information including the uncertain contact information, and correct the tag information in response to identification of the user.

7. The electronic device of claim 1, wherein the creation module is further configured to detect a sharing means configured in the contact information related to each of the plurality of file groups, and link the detected sharing means with the plurality of file groups.

8. The electronic device of claim 1, wherein the creation module is further configured to, if at least one piece of the image data that has transmission information indicating that the image data has been transmitted to the related contact information, inform a user of the existence of the at least one piece of the image data that has been transmitted to the related contact information.

9. The electronic device of claim 1, wherein the creation module is further configured to, if the image data includes transmission information, display the transmission information including the contact information.

10. The electronic device of claim 1, wherein the transmission module is further configured to transmit each of the plurality of file groups to the related contact information by using a sharing means selected by a user,

11. The electronic device of claim 1, wherein the transmission module is further configured to transmit each of the plurality of file groups to the related contact information by using a related sharing means.

12. The electronic device of claim 1, wherein the transmission module is further configured to transmit each of the plurality of file groups to the related external devices by using short-range communication.

13. A method for controlling transmission of an electronic device, the method comprising the steps of:
sorting one or more pieces of image data based on contact information included in tag information of each of the one or more pieces of image data;
creating a plurality of file groups related to the contact information; and
transmitting each of the plurality of file groups to the related contact information.

14. The method of claim 13, further comprising displaying the plurality of file groups and the contact information related to the plurality of file groups.

15. The method of claim 13, further comprising:
when short-range communication is selected as a sharing means, for each of the plurality of file groups:
detecting at least one external device that has contact information identical to the related contact information, from among one or more external devices discovered through a scanning operation; and
designating the at least one external device as an electronic device to which a respective file group can be transmitted.

16. The method of claim 13, further comprising:
when short-range communication is selected as a sharing means, displaying a list of at least one external device discovered through a scanning operation; and
designating an external device selected from the list as the electronic device to which a file group selected from the plurality of file groups can be transmitted.

17. The method of claim 13, wherein creating the plurality of file groups comprises:
determining whether a contact database includes contact information for at least one piece of the image data, when the at least one piece of the image data does not have tag information;
creating a certain file group including the at least one piece of the image data, when the contact database does not have the contact information for the at least one piece of the image data; and
transmitting the certain file group including the at least one piece of the first image data to contact information selected by a user.

18. The method of claim 13, further comprising:
when the tag information includes uncertain contact information, requesting a user to identify the tag information including the uncertain contact information; and
correcting the tag information in response to identification of the user.

19. The method of claim 13, further comprising:
detecting a sharing means configured in the contact information related to each of the plurality of file groups; and
linking the detected sharing means with the plurality of file groups.

20. The method of claim 13, further comprising, if at least one piece of the image data that has transmission information indicating that the image data has been transmitted to the related contact information, informing a user of the existence of the image data that has formerly transmitted to the related contact information.

21. The method of claim 13, further comprising, if the image data includes transmission information, displaying the transmission information including the contact information.

22. The method of claim 13, wherein each of the plurality of file groups are transmitted to the related contact information by using a sharing means selected by a user.

23. The method of claim 13, wherein each of the plurality of file groups are transmitted to the related contact information by using a related sharing means.

24. The method of claim 13, wherein each of the plurality of file groups are transmitted to the related external devices by using short-range communication.
